(19) United States
(12) Patent Application Publication
(10) Pub. No.: US 2020/0133998 A1
(43) Pub. Date: Apr. 30, 2020

(54) ESTIMATION METHOD, ESTIMATION APPARATUS, AND COMPUTER-READABLE RECORDING MEDIUM

(71) Applicant: FUJITSU LIMITED, Kawasaki-shi (JP)

(72) Inventors: TOSHIO ITO, Kawasaki (JP); Naoki Hamada, Kawasaki (JP)

(73) Assignee: FUJITSU LIMITED, Kawasaki-shi (JP)

(21) Appl. No.: 16/661,303

(22) Filed: Oct. 23, 2019

(30) Foreign Application Priority Data
Oct. 26, 2018 (JP) 2018-202222

(51) Int. Cl. G06F 17/18; G06N 20/10; G06N 7/00; G06Q 10/04

(52) U.S. Cl. CPC G06F 17/18; G06Q 10/04; G06N 7/005; G06N 20/10

(57) ABSTRACT

A non-transitory computer-readable recording medium stores therein an estimation program that causes a computer to execute a process including: generating a kernel regression function regarding a movement of a movable object by using interval data that is included in input data regarding the movement of the movable object and that is a specific number of interval data sets selected in accordance with an environmental condition; calculating an objective variable with regard to the environmental condition that is the estimation target based on the kernel regression function; and performing estimating used for an optimization problem regarding the movable object that moves under the environmental condition that is not discontinuous.

### CROSS-REFERENCE TO RELATED APPLICATIONS

This application is based upon and claims the benefit of priority of the prior Japanese Patent Application No. 2018-202222, filed on Oct. 26, 2018, the entire contents of which are incorporated herein by reference.

### FIELD

The embodiment(s) discussed herein is (are) related to an estimation program, an estimation method, and an estimation apparatus.

### BACKGROUND

Conventionally, the performance (e.g., the amount of consumed fuel) of a movable object with regard to an environmental condition is estimated, and the route of the movable object is optimized based on an estimation result. Here, the estimation on the performance of the movable object is conducted by kernel regression in which the environmental condition is an explanatory variable and the estimated value of the performance is an objective variable. For a kernel regression function used for kernel regression, the explanatory variable and the objective variable are generated from known learning data. By inputting an environmental condition to the kernel regression function, the estimated value of the performance of the movable object with regard to the environmental condition is obtained.

K—nearest neighbor crossover kernel regression is known as a technique for increasing the speed of the calculation of an estimated value in kernel regression. K—nearest neighbor crossover kernel regression is a technique in which, when kernel that is a multivariate Gaussian density is calculated with regard to each learning data set, the average value and the variance value of each kernel are calculated from the k—nearest neighbor in each learning data set. In k—nearest neighbor crossover kernel regression, as kernel is calculated by using the k—nearest neighbor in each learning data set, the calculation time is expected to decrease as compared with a case where kernel is calculated with regard to each learning data set by using all the other learning data sets.

Patent Document 1: Japanese Laid-open Patent Publication No. 2004-118658

According to the above-described technique, however, the estimation on the performance of the movable object at a high speed and with high accuracy is difficult in some cases.

For example, in the above-described k—nearest neighbor crossover kernel regression, learning data is refined into k—nearest neighbors to perform the calculation for generating a kernel regression function. Conversely, for the calculation on an estimated value by using a kernel regression function, the calculation is executed by using all the learning data, and therefore a high-speed calculation is sometimes difficult.

There is a physical characteristic that a similar environmental condition causes a similar performance with regard to the movement of a movable object. For this reason, it is possible that the learning data used for the calculation of an estimated value using a kernel regression function is refined into the one having the occurrence time or the value of a specific explanatory variable similar to those of the estimation data. However, the environmental condition is often multidimensional, and therefore it is sometimes difficult to improve the estimation accuracy with the above-described simple refinement.

### SUMMARY

According to an aspect of an embodiment, a non-transitory computer-readable recording medium stores therein an estimation program that causes a computer to execute a process including: generating a kernel regression function regarding a movement of a movable object by using interval data that is included in input data regarding the movement of the movable object and that is a specific number of interval data sets selected in accordance with an environmental condition; calculating an objective variable with regard to the environmental condition that is the estimation target based on the kernel regression function; and performing estimating used for an optimization problem regarding the movable object that moves under the environmental condition that is not discontinuous.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram that illustrates a functional configuration of an estimation apparatus according to an embodiment;

FIG. 2 is a diagram that illustrates k2—nearest neighbors in an explanatory variable space;

FIG. 3 is a diagram that illustrates learning data of k—nearest neighbors;

FIG. 4 is a diagram that illustrates a confidence interval range of learning data;

FIG. 5 is a diagram that illustrates the setting of k2;

FIG. 6 is a diagram that illustrates the determination on a route;

FIG. 7 is a flowchart that illustrates the flow of an estimation process;

FIG. 8 is a diagram that illustrates an error rate;

FIG. 9 is a diagram that illustrates a learning time;

FIG. 10 is a diagram that illustrates an estimation time;

FIG. 11 is a diagram that illustrates a confidence interval range; and

FIG. 12 is a diagram that illustrates an example of a hardware configuration.

### DESCRIPTION OF EMBODIMENTS

Preferred embodiments of the present invention will be explained with reference to accompanying drawings. The present invention is not limited to an embodiment. Furthermore, embodiments may be combined as appropriate as long as the consistency is ensured.

### [a] First Embodiment

An estimation apparatus according to an embodiment estimates the performance of a movable object with regard to an environmental condition. Furthermore, a result of the performance estimation is used to optimize the route of a movable object. For example, the movable object is an automobile, an aircraft, or a vessel. Specifically, the estimation apparatus receives an input of the environmental condition and outputs an estimated value. Furthermore, the estimation apparatus may determine the optimum route based on an estimated value.

For example, the environmental condition is the fluctuation velocity of a medium in an area from a movable object by equal to or less than a predetermined distance, the shape of a medium, or the remaining amount of a power resource of a movable object. Specifically, the environmental condition is a wind velocity, a wind direction, a wave velocity, a wave height, or a road gradient around the area where a movable object is placed, the remaining amount of a power resource, such as gasoline or battery, or the like.

Furthermore, the performance estimated by the estimation apparatus is, for example, the velocity of a movable object, or the amount of a consumed power resource. With the estimation apparatus, it is possible to select the route on which the destination may be reached in the shortest time, the route for which the smallest amount of fuel is consumed, or the like, from multiple routes.

The estimation apparatus outputs an estimated value by using a regression model. Here, the environmental condition and the estimated value are an explanatory variable and an objective variable, respectively, in the regression model. The explanatory variable in the regression model may be a representation of multiple environmental conditions using a multidimensional vector. Further, the estimation apparatus uses a kernel regression model using kernel.

Learning data is data in which both the environmental condition and the performance of the movable object with regard to the environmental condition are known. Furthermore, estimation data is the target data in which the environmental condition is known and the performance of the movable object is to be estimated.

### Functional Configuration

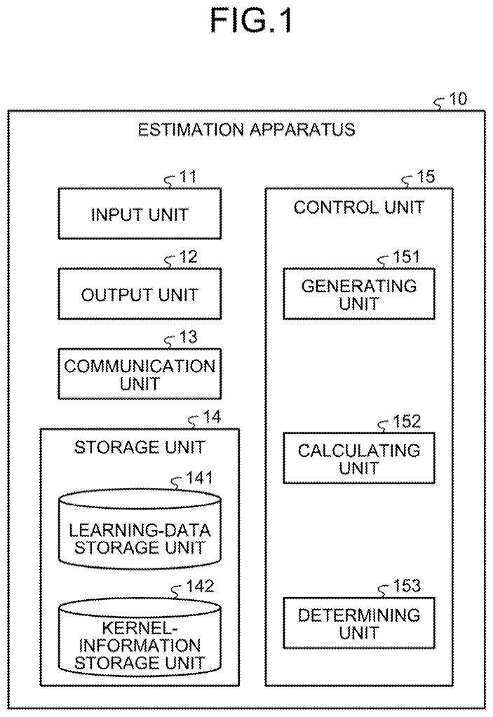

A functional configuration of the estimation apparatus according to the embodiment is explained with reference to FIG. 1. FIG. 1 is a functional block diagram that illustrates a functional configuration of the estimation apparatus according to the embodiment. As illustrated in FIG. 1, an estimation apparatus 10 includes an input unit 11, an output unit 12, a communication unit 13, a storage unit 14, and a control unit 15.

The input unit 11 is a device for a user to input information. For example, the input unit 11 is a mouse and a keyboard. The output unit 12 is a display, or the like, which presents a screen. The input unit 11 and the output unit 12 may be a touch panel display.

The communication unit 13 is an interface for communicating data with a different device. For example, the communication unit 13 is a NIC (Network Interface Card) to communicate data via the Internet.

The storage unit 14 is an example of a storage device that stores data, a program executed by the control unit 15, and the like, and it is, for example, a hard disk or a memory. The storage unit 14 includes a learning-data storage unit 141 and a kernel-information storage unit 142.

The learning-data storage unit 141 stores previously acquired learning data that is a combination of an environmental condition and a performance of a movable object. The learning data is represented as (xᵢ,yᵢ) (i=1, 2, . . . , n) where the explanatory variable is xᵢ and the objective variable is yᵢ. Here, n is the number of sets of learning data. Further, xᵢ may be a multidimensional vector.

The kernel-information storage unit 142 stores, for example, a calculation value used for kernel regression. For example, the kernel-information storage unit 142 stores kernel and a confidence interval range that are previously calculated for each learning data set. The method for calculating the kernel and the confidence interval range is described later.

The control unit 15 is implemented when, for example, a CPU (Central Processing Unit) or an MPU (Micro Processing Unit) executes a program stored in an internal storage device by using a RAM as a work area. The control unit 15 may be implemented by an integrated circuit such as ASIC (Application Specific Integrated Circuit) or FPGA (Field Programmable Gate Array). The control unit 15 includes a generating unit 151, a calculating unit 152, and a determining unit 153.

According to the present embodiment, input data, which is input to the input unit 11, regarding the movement of a movable object is treated as learning data. In other words, it can be said that the learning data is an example of input data. The generating unit 151 generates a kernel regression function regarding the movement of a movable object by using interval data that is included in the learning data and that is the specific number of interval data sets selected in accordance with the environmental condition that is the estimation target. Further, the generating unit 151 generates a kernel regression function by using interval data that is selected from the learning data including at least any of the fluctuation velocity of a medium in an area from the movable object by equal to or less than a predetermined distance, the shape of a medium, and the remaining amount of a power resource of the movable object.

The learning data is stored in the learning-data storage unit 141. According to the present embodiment, the specific number corresponding to the environmental condition that is the estimation target is referred to as k2. The interval data is, in other words, the learning data included in the k2—nearest neighbor. The medium is, for example, air, water, or the ground. The power resource is, for example, gasoline, or battery. As described above, the environmental condition is a wind velocity, a wind direction, a wave velocity, a wave height, or a road gradient around the area where a movable object is placed, the remaining amount of a power resource, such as gasoline or battery, or the like.

The generating unit 151 uses, as k2, for example, the number that is previously set such that the difference between the objective variable calculated based on the kernel regression function generated by using a k2—nearest neighbor and the objective variable calculated based on the kernel regression function generated by using all the learning data regarding the movement of the movable object is less than a predetermined value. For example, although the generating unit 151 may set the value of k2 in the range of from 1 to n, the generating unit 151 uses, as k2, the value that is determined through tuning to enable high-speed calculation without decreasing the estimation accuracy. For example, in some cases, the generating unit 151 may set k2 to a small number equal to or less than 100 even though the number of learning data sets is more than 10,000. Thus, according to the embodiment, as the number of data sets used to generate a kernel function may be small, high-speed calculation of kernel regression is possible.

The generating unit 151 generates a kernel regression function by using the specific number of k2—nearest neighbors that are selected from the learning data regarding the movement of the movable object in ascending order of the Euclidean distance from the estimation data indicating the environmental condition that is the estimation target. Here, the environmental condition that is the estimation target is, in other words, the explanatory variable in the regression model of the estimation data. That is, the generating unit 151 calculates the Euclidean distance between the explanatory variable in the estimation data and the explanatory variable in each learning data set.

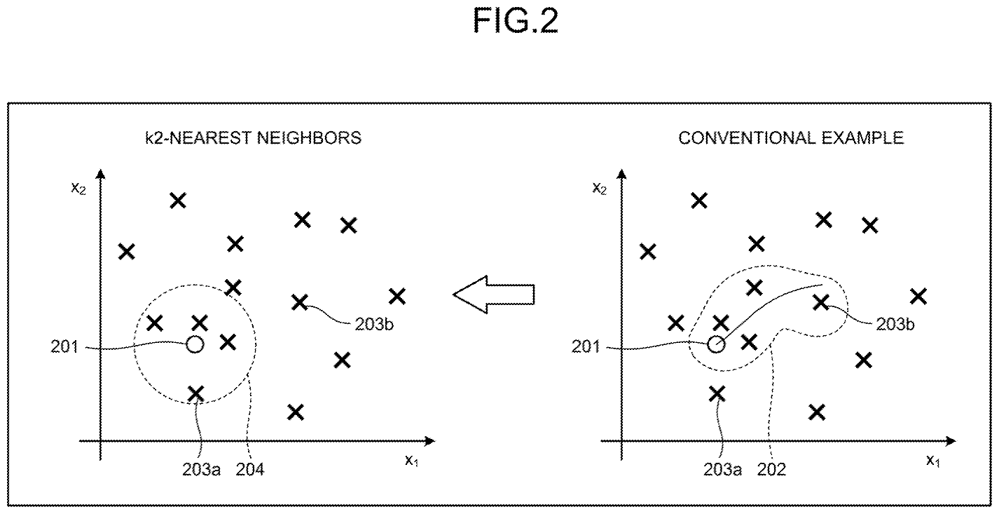

FIG. 2 is a diagram that illustrates k2—nearest neighbors in an explanatory variable space. Here, x₁ and x₂ are terms of an explanatory variable. Here, for ease of explanation, the explanatory variable is two-dimensional; however, in actuality, the explanatory variable may be three-dimensional or more. Furthermore, O in FIG. 2 is the explanatory variable of the estimation data. Moreover, X in FIG. 2 is the explanatory variable of the learning data.

A conventional example in FIG. 2 is an example of the case whore neighbors of the data occurring in a specific time range before the occurrence of the estimation data is used to generate a kernel regression function. In this case, an area 202 of k2—nearest neighbors of an explanatory variable 201 in the estimation data includes not an explanatory variable 203a but an explanatory variable 203b in the learning data.

Conversely, k2—nearest neighbors of FIG. 2 illustrates the method according to the present embodiment. In this case, an area 204 of neighbors of the explanatory variable 201 in the estimation data includes not the explanatory variable 203b but the explanatory variable 203a in the learning data.

Here, in consideration of the above-described physical characteristic that a similar environmental condition causes a similar performance regarding the movement of a movable object, it is considered that the explanatory variable 203a aids in improving the estimation accuracy as compared with the explanatory variable 203b. Thus, as compared with the conventional case in FIG. 2, the method according to the present embodiment may improve the estimation accuracy of the performance of the movable object.

Here, the learning data included in a k2—nearest neighbor is represented by Equation (1).

xᵢ_{₁}, xᵢ_{₂}, . . . , xᵢ_{ₖ₂} (1)

Furthermore, a k2—nearest neighbor Xₖ₂ is represented by Equation (2). Here, j=1, 2, . . . , k2.

Xₖ₂ [symbol] Xᵢ_{ⱼ} (2)

The generating unit 151 previously calculates a kernel K (x, xᵢ) with regard to each learning data set and stores it in the kernel-information storage unit 142. Here, the generating unit 151 is capable of calculating the kernel in the same method as that in the conventional k—nearest neighbor crossover kernel regression. Specifically, the generating unit 151 calculates the kernel of xᵢ from the explanatory variable of the learning data included in the k—nearest neighbor of xᵢ. Here, k is a natural number that is set separately from k2 in the k2—nearest neighbor.

The generating unit 151 generates a kernel regression function represented by Equation (3) by using the calculated kernel.

$$\tilde{f} ( x ) = \frac{\sum \text{?} K ( x , {x}_{i} \text{?} ) {y}_{i} \text{?}}{{\sum }_{\text{?}} \text{?} K ( x , {x}_{i} \text{?} )} \\ \text{?} \text{indicates text missing or illegible when filed} \qquad ( 3 )$$

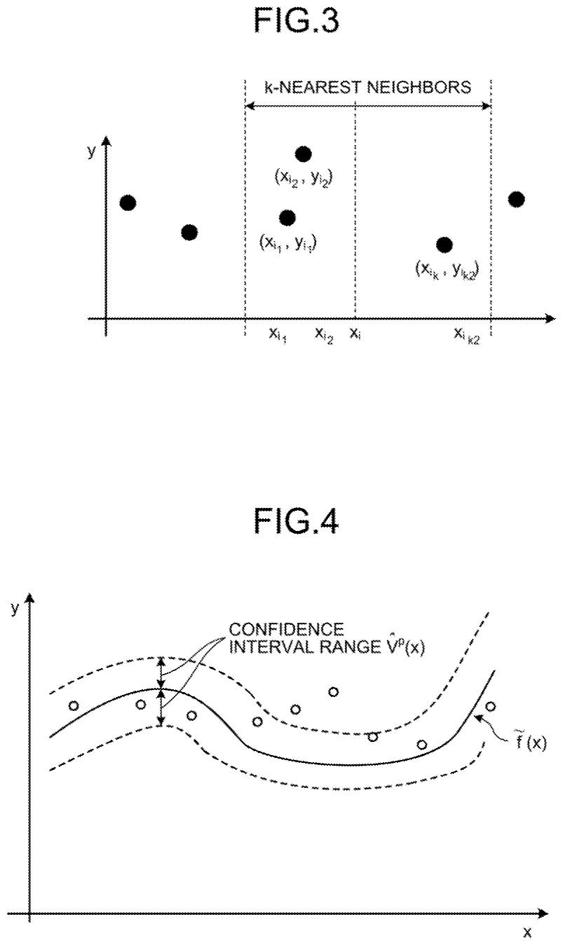

The k—nearest neighbor is determined by the explanatory variable xᵢ of the learning data as illustrated in FIG. 3. FIG. 3 is a diagram that illustrates learning data of the k—nearest neighbor. As illustrated in FIG. 3, the explanatory variable in the learning data of the k—nearest neighbor is included in a certain range with the explanatory variable xᵢ as a center.

The generating unit 151 calculates a confidence interval range with regard to each learning data set according to Equation (4). The confidence interval is a variance value indicating the variance of an estimated value that is output by a kernel regression function.

$${V}^{p} ( {x}_{i} ) = \frac{1}{k} {\sum }_{j = 1}^{k} {( {y}_{i , j} - \tilde{f} ( {x}_{i} ) )}^{2} \qquad ( 4 )$$

The generating unit 151 generates a function illustrated in Equation (5) to calculate a confidence interval range of estimation data. FIG. 4 is a diagram that illustrates a confidence interval range.

$${\hat{V}}^{p} ( x ) = \frac{\sum \text{?} K ( x , {x}_{i} \text{?} ) {V}^{p} ( {x}_{i} \text{?} )}{\sum \text{?} K ( x , {x}_{i} \text{?} )} \\ \text{?} \text{indicates text missing or illegible when filed} \qquad ( 5 )$$

The generation of a function may simply refer to the calculation and the storage of a parameter for performing a calculation using a function. For example, the generating unit 151 may simply calculate the Kernel K(x,xi) and a confidence interval V^{p}(xᵢ) of each learning data set as parameters used in Equation (3) and Equation (4) and store them in the storage unit 14.

The calculating unit 152 calculates an objective variable with regard to the environmental condition that is the estimation target based on the kernel regression function. Specifically, the calculating unit 152 substitutes the explanatory variable of the estimation data into x in Equation (3) to calculate an estimated value.

The calculating unit 152 calculates a confidence interval of the objective variable based on the kernel regression function generated by using interval data and the environmental condition of each interval data set. Specifically, the calculating unit 152 substitutes the explanatory variable of the estimation data into x in Equation (5) to calculate a confidence interval.

The calculating unit 152 way calculate an objective variable with regard to the environmental condition that is the estimation target based on the kernel regression function generated by using all the learning data regarding the movement of the movable object when the confidence interval is more than a predetermined threshold. In this case, the calculating unit 152 first calculates a confidence interval of the estimation data. Here, the larger the confidence interval, the lower the accuracy of the calculated estimated value. Therefore, when the calculated confidence interval of the estimation data is more than a threshold, the calculating unit 152 calculates an estimated value by using all the learning data without using the k2—nearest neighbor. The estimation result in this case is the same as the result obtained when k2 is replaced with the total number n of learning data sets. Furthermore, the calculating unit 152 may increase the value of k2 in the range of less than n in a case where it is detected that a discontinuous environment change occurs due to a confidence interval range.

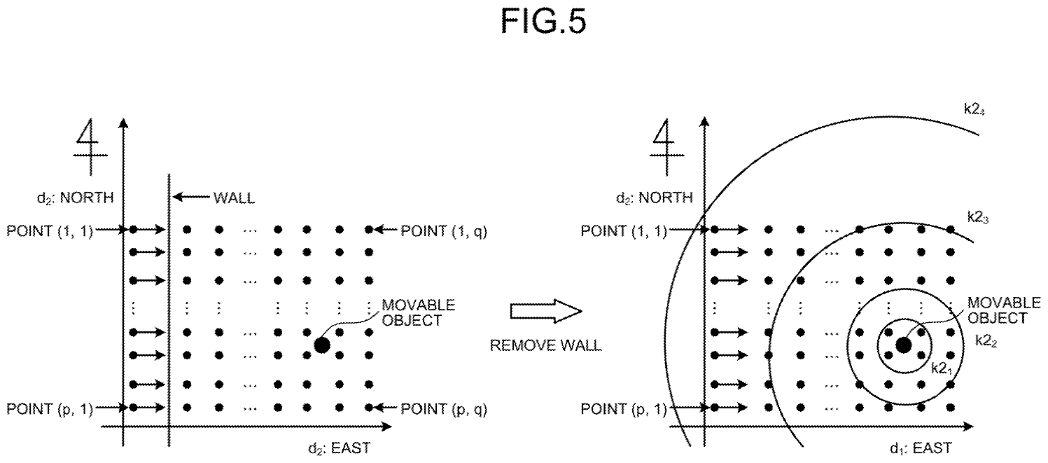

Here, with reference to FIG. 5, an explanation is given of a case where there is a need to increase the value of k2. FIG. 5 is a diagram that illustrates the setting of k2. As illustrated in FIG. 5, a movable object at a certain point is moved with the wind. At points (1,1) to (p,1) in the east area of the movable object, the wind blows towards the west. In the beginning, the wind is blocked by the wall, and when the wall is removed at a certain point, the wind blows toward the movable object. The environmental condition at the moment when the wall is removed is estimation data.

Here, as illustrated in FIG. 5, when the value of k2 is k2₁ to k2₃, it is difficult for the estimation apparatus 10 to conduct estimation in consideration of the wind situation at the points (1,1) to (p,1) by using the data included in k2—nearest neighbors. Conversely, when the value of k2 is increased to k2₄, the estimation apparatus 10 may conduct estimation by using the data included in k2—nearest neighbors in consideration of the wind situation at the points (1,1) to (p,1).

FIG. 5 is an example of the hypothetical situation where the wind is blocked by the wall and, at a certain point, the wall is removed. In this case, the environmental condition changes discontinuously since the wall is removed. In such a situation, the estimation accuracy is sometimes decreased when k2 is limited to a small value.

On the contrary, when changes in the environmental condition are not discontinuous, the estimation accuracy using the k2—nearest neighbor is increased. It is considered that extreme changes in the environmental condition as in FIG. 5 are unlikely to occur in an environment where a movable object, such as vehicle, aircraft, or vessel, is placed. Therefore, it is considered that kernel regression using the k2—nearest neighbor according to the present embodiment is advantageous for the optimization problem of this kind of movable object. Cases where changes in the environmental condition are not discontinuous include a case where changes in the environmental condition are continuous.

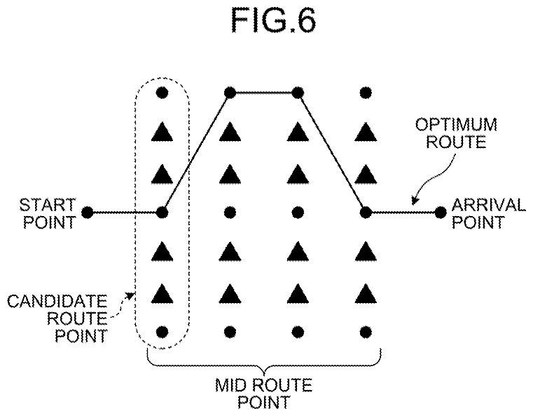

The determining unit 153 determines a route based on the estimated value calculated by the calculating unit 152. With reference to FIG. 6, the determination on a route is described. FIG. 6 is a diagram that illustrates the determination on a route. For example, when the movable object is present at the start point in FIG. 6, the calculating unit 152 estimates the amount of a consumed traveling resource with regard to each candidate route point. Here, the explanatory variable of the estimation data may include the direction of each candidate route point and the distance to each candidate route point.

In the example of FIG. 6, as there are seven candidate route points, the calculating unit 152 calculates seven estimated values. Then, the determining unit 153 selects the optimum one from the seven estimated values and determines that the next route is the route toward the candidate route point corresponding to the selected estimated value. The estimation apparatus 10 repeats this process to determine the optimum route.

### Flow of Process

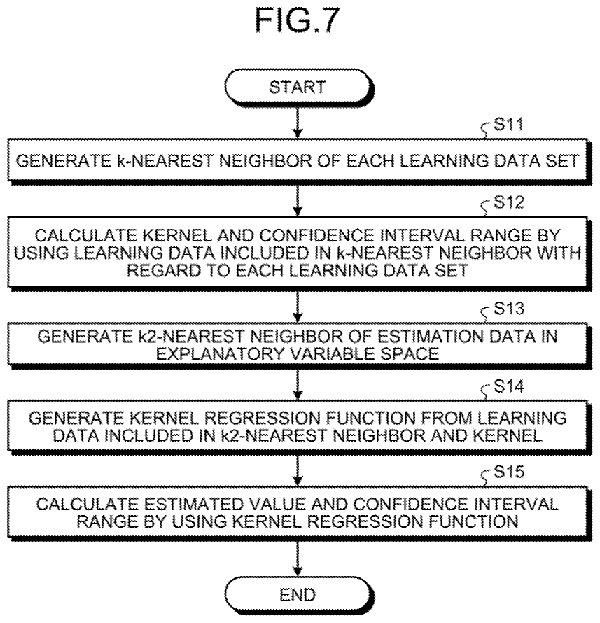

With reference to FIG. 7, the flow of the estimation process by the estimation apparatus 10 is described. FIG. 7 is a flowchart that illustrates the flow of the estimation process. As illustrated in FIG. 7, the estimation apparatus 10 first generates a k—nearest neighbor of each learning data set (Step S11). Then, the estimation apparatus 10 calculates kernel and a confidence interval range by using the learning data included in the k—nearest neighbor with regard to each learning data set (Step S12).

Here, the processes at Step S11 and Step S12 are performed in a learning phase. The estimation apparatus 10 may previously conduct the process in the learning phase before the movable object actually moves. Conversely, the process after Step S13 is performed in an estimation phase. The estimation apparatus 10 performs the process in the estimation phase in accordance with the movement of the movable object. For this reason, the high-speed process in the estimation phase is particularly desired.

After obtaining the estimation data, the estimation apparatus 10 generates a k2—nearest neighbor of the estimation data in the explanatory variable space (Step S13). Then, a kernel regression function is generated from the learning data included in the k2—nearest neighbor and the kernel (Step S14). Then, the estimation apparatus 10 uses the kernel regression function to calculate an estimated value and a confidence interval range (Step S15).

### Advantageous Effect

As described above, the estimation apparatus 10 generates a kernel regression function regarding the movement of a movable object by using interval data that is included in the input data regarding the movement of the movable object and that is the specific number of interval data sets selected in accordance with the environmental condition that is the estimation target. The estimation apparatus 10 calculates an objective variable with regard to the environmental condition that is the estimation target based on the kernel regression function. In this manner, the estimation apparatus 10 generates a kernel regression function by using the specific number of learning data sets in the neighborhood of the estimation data instead of all the learning data. Thus, the estimation apparatus 10 is capable of calculating an objective variable at a high speed and with high accuracy.

The estimation apparatus 10 generates a kernel regression function by using the specific number of interval data sets selected from the learning data regarding the movement of a movable object in ascending order of the Euclidean distance from the estimation data indicating the environmental condition that is the estimation target. Thus, the estimation apparatus 10 is capable of easily generating the k2—nearest neighbor.

The estimation apparatus 10 calculates the confidence interval of an objective variable based on the kernel regression function generated by using interval data and the environmental condition of each interval data set. In this manner, the estimation apparatus 10 is capable of calculating a confidence interval range by using a kernel regression function. Thus, with the estimation apparatus 10, it is possible to evaluate the validity of k2 and the estimation accuracy.

When the confidence interval is more than a predetermined threshold, the estimation apparatus 10 calculates an objective variable with regard to the environmental condition that is the estimation target based on the kernel regression function generated by using all the learning data regarding the movement of a movable object. In this way, the estimation apparatus 10 enables a flexible switchover as to whether the k2—nearest neighbor is to be used depending on a circumstance.

With the estimation apparatus 10, k2 may be previously set in accordance with the desired estimation accuracy. Thus, the estimation apparatus 10 makes it possible to maintain the desired estimation accuracy and increase the calculation speed.

The estimation apparatus 10 generates a kernel regression function by using interval data that is selected from input data including at least any of the velocity of a medium in an area from the movable object by less than a predetermined distance and the remaining amount of a power resource of the movable object. Thus, by using an environmental condition that does not change discontinuously as an explanatory variable, it is possible to effectively use kernel regression using the k2—nearest neighbor.

Although the value of k2 is previously set or is changed in accordance with a confidence interval range according to the above-described embodiment, the estimation apparatus 10 may set k2 by using a different method. For example, the estimation apparatus 10 may receive the value of k2 designated by a user on an as-needed basis or may set the value of k2 as large as possible within the range such that the upper limit of the previously set calculation time is not exceeded.

### Experimental Result

Results of experiments conducted for the comparison in the estimation accuracy and the processing speed between the method according to the present embodiment and the conventional method are described. Here, according to the conventional method, an estimated value is calculated by using all the learning data without using the k2—nearest neighbor. That is, the conventional method is to perform the calculation of Equation (3) on all the n learning data sets. Therefore, it is considered that, according to the conventional method, the generation of the k2—nearest neighbor is not needed but the amount of calculation to calculate an estimated value is increased. Conversely, according to the present embodiment, it is considered that, although the amount of calculation to calculate an estimated value is decreased, the processing amount is increased due to the generation of the k2—nearest neighbor.

Here, the calculation of an estimated value using the k2—nearest neighbor is referred to as an “approximate calculation”. Therefore, in some cases, the method according to the present embodiment is described as, for example, “the case where an approximate calculation is performed” and the conventional method as “the case where an approximate calculation is not performed”.

The experiment data set is Power Plant published by UCI Machine Learning (URL:

https://archive.ics.uci.edu/ml/index.php). Power Plant can be said to be a data set regarding an environmental condition that continuously changes, and therefore it is considered that the same experimental result as that in the case of a movable object is obtained. The explanatory variable of Power Plant is four-dimensional, the objective variable is one-dimensional, the number of learning data sets is 8575, and the number of estimation data sets for verification is 952.

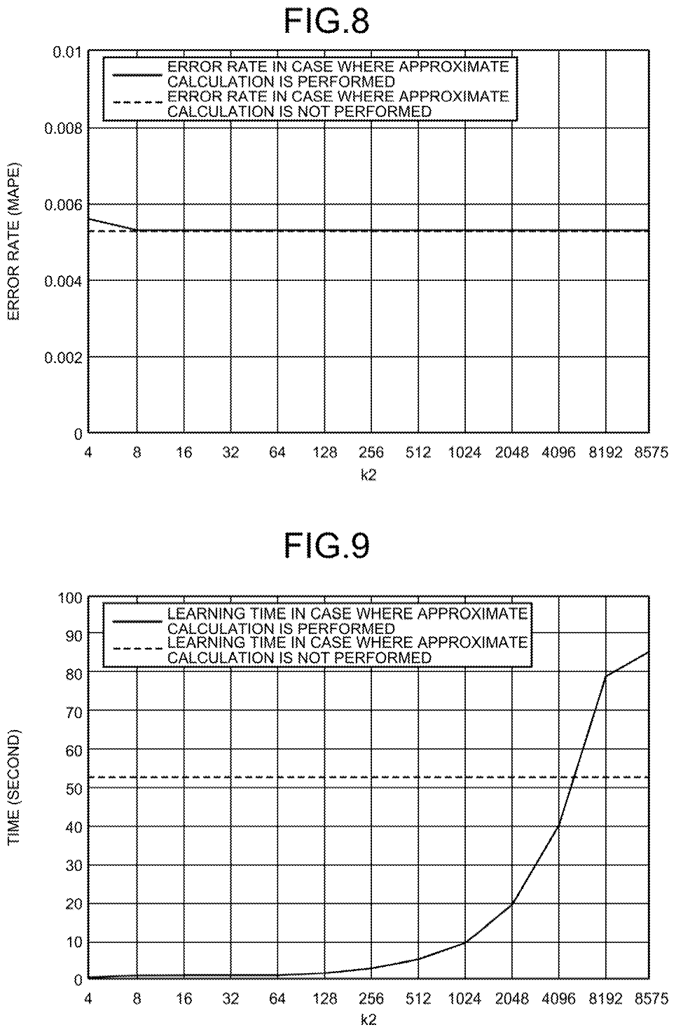

FIG. 8 is a diagram that illustrates an error rate. As illustrated in FIG. 8, when k2=8, the error rate is substantially equal in the case where an approximate calculation is performed and in the case where an approximate calculation is not performed. Furthermore, when k2>8, the error rate in the case where an approximate calculation is performed is converged into the error rate in the case where an approximate calculation is not performed.

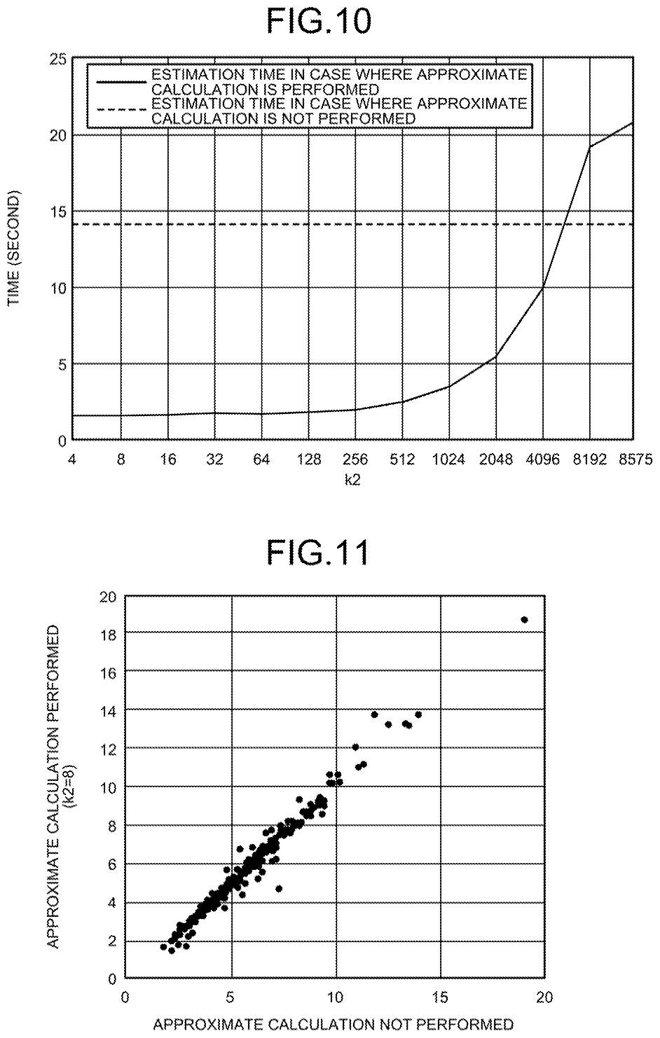

FIG. 9 is a diagram that illustrates a learning time. The learning time of FIG. 9 includes the calculation time of the confidence interval range in Equation (4). As illustrated in FIG. 9, in a case where an approximate calculation is performed, the learning time is longer as k2 is larger. This is because tree search is conducted when the k2—nearest neighbor is generated. Furthermore, when k2>8192, the learning time in a case where an approximate calculation is performed is longer than the learning time in a case where an approximate calculation is not performed. The estimation time illustrated in FIG. 10 has the same pattern as that in FIG. 9. FIG. 10 is a diagram that illustrates the estimation time.

Thus, it is understood that, when the setting is, for example, k2=8, the method according to the present embodiment may achieve the estimation accuracy equivalent to that according to the conventional method and further perform a process in the learning phase at a 53-times higher speed and a process in the estimation phase at an 8.7-times higher speed.

FIG. 11 is a diagram that illustrates a confidence interval range. As illustrated in FIG. 11, the confidence interval range has substantially the same value in a case where an approximate calculation is performed and k2=8 and in a case where an approximate calculation is not performed. This indicates that, according to the present embodiment, although an approximate calculation is performed, the confidence interval range equivalent to that in a case where an approximate calculation is not performed is achieved.

An increase in the calculation speed enables a wider range of selection of a route for the movable object and a more detailed route setting. For example, according to the present embodiment, even though a route point indicated by a triangle is added to a route point indicated by a circle that is conventionally used, as illustrated in FIG. 6, the route optimization may be executed at the speed equal to or higher than the conventional speed.

### System

The processing procedure, the control procedure, the specific name, information including various types of data and parameters described above in the description and the drawings are optionally alterable unless otherwise specified. Furthermore, a specific example, a distribution, a numerical value, and the like, described in the embodiment are merely examples, and they are optionally alterable.

Components of each device illustrated in the drawings are conceptual in terms of functions and do not necessarily need to be physically configured as illustrated in the drawings. Specifically, specific forms of separation and combination of each device are not limited to those illustrated in the drawings. That is, a configuration may be such that all or some of them are functionally or physically separated or combined in an arbitrary unit depending on various types of loads or usage. Furthermore, all or any of various processing functions performed by each device may be implemented by a CPU and a program analyzed and executed by the CPU or may be implemented as wired logic hardware.

### Hardware

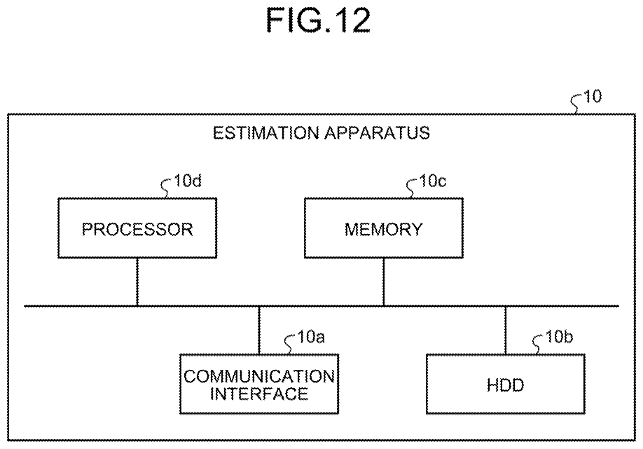

FIG. 12 is a diagram that illustrates an example of a hardware configuration. As illustrated in FIG. 12, the estimation apparatus 10 includes a communication interface 10a, an HDD (Hard Disk Drive) 10b, a memory 10c, and a processor 10d. The units illustrated in FIG. 12 are connected to one another via a bus, or the like.

The communication interface 10a is a network interface card, or the like, to communicate with a different server. The HDD 10b stores a program and a DB for performing the functions illustrated in FIG. 1.

The processor 10d reads a program for executing the same process as that of each processing unit illustrated in FIG. 1 from the HDD 10b, or the like, and loads it into the memory 10c to execute the process for performing the function described in FIG. 3, and the like. That is, this process performs the same function as that of each processing unit included in the estimation apparatus 10. Specifically, the processor 10d reads the program having the same functions as those of the generating unit 151, the calculating unit 152, and the determining unit 153 from the HDD 10b, or the like. Then, the processor 10d performs the process for performing the same processes as those of the generating unit 151, the calculating unit 152, the determining unit 153, and the like.

Thus, the estimation apparatus 10 reads and executes the program to operate as an information processing apparatus that implements a classification method. Furthermore, the estimation apparatus 10 may also read the above-described program from a recording medium by using a medium reading device and execute the read program described above to perform the same function as that in the above-described embodiment. The program described in this different embodiment is not necessarily performed by the estimation apparatus 10. For example, the present invention is also applicable to a case where the program is executed by a different computer or server or a case where the program is executed by them in cooperation.

The program may be distributed via a network such as the Internet. The program is recorded in a recording medium readable by a computer, such as hard disk, flexible disk (FD), CD-ROM, MO (Magneto-Optical disk), or DVD (Digital Versatile Disc) so that it may be executed by being read from the recording medium by the computer.

According to an aspect of the present invention, it is possible to estimate the performance of a movable object at a high speed and with high accuracy.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein an estimation program that causes a computer to execute a process comprising:
generating a kernel regression function regarding a movement of a movable object by using interval data that is included in input data regarding the movement of the movable object and that is a specific number of interval data sets selected in accordance with an environmental condition;
calculating an objective variable with regard to the environmental condition that is the estimation target based on the kernel regression function; and
performing estimating used for an optimization problem regarding the movable object that moves under the environmental condition that is not discontinuous.

2. The non-transitory computer-readable recording medium according to claim 1, wherein the generating includes generating the kernel regression function by using the specific number of interval data sets that are selected from the input data regarding the movement of the movable object in ascending order of a Euclidean distance from estimation data indicating the environmental condition that is the estimation target.

3. The non-transitory computer-readable recording medium according to claim 1, wherein the calculating includes calculating a confidence interval of the objective variable based on the kernel regression function generated by using the interval data and an environmental condition of each of the interval data sets.

4. The non-transitory computer-readable recording medium according to claim 3, wherein the calculating includes calculating an objective variable with regard to the environmental condition that is the estimation target based on the kernel regression function generated by using all the input data regarding the movement of the movable object when the confidence interval is equal to or more than a predetermined threshold.

5. The non-transitory computer-readable recording medium according to claim 1, wherein the generating includes using, as the specific number, a number that is previously set such that a difference between an objective variable calculated based on the kernel regression function generated by using the interval data and an objective variable calculated based on the kernel regression function generated by using all the input data regarding the movement of the movable object is equal to or less than a predetermined value.

6. The non-transitory computer-readable recording medium according to claim 1, wherein the generating includes generating the kernel regression function by using the interval data that is selected from input data including at least any of a fluctuation velocity of a medium in an area from the movable object by equal to or less than a predetermined distance, a shape of a medium, and a remaining amount of a power resource of the movable object.

7. An estimation method comprising:
generating a kernel regression function regarding a movement of a movable object by using interval data that is included in input data regarding the movement of the movable object and that is a specific number of interval data sets selected in accordance with an environmental condition;
calculating an objective variable with regard to the environmental condition that is the estimation target based on the kernel regression function; and
performing estimating used for an optimization problem regarding the movable object that moves under the environmental condition that is not discontinuous, by a processor.

8. An estimation apparatus comprising:
a processor configured to:
generate a kernel regression function regarding a movement of a movable object by using interval data that is included in input data regarding the movement of the movable object and that is a specific number of interval data sets selected in accordance with an environmental condition;
calculate an objective variable with regard to the environmental condition that is the estimation target based on the kernel regression function; and
perform estimating used for an optimization problem regarding the movable object that moves under the environmental condition that is not discontinuous.
